(19) United States
(12) Patent Application Publication
(10) Pub. No.: US 2026/0230408 A1
(43) Pub. Date: Aug. 6, 2026

(54) METHOD, APPARATUS AND SYSTEM FOR PROVIDING A CONFEDERATION NETWORK IN A COMMUNICATION SYSTEM

(71) Applicant: Huawei Technologies Co., Ltd., Shenzhen (CN)

(72) Inventors: Wei Tan, Shenzhen (CN); Hang Zhang, Ottawa (CA); Xu Li, Nepean (CA)

(21) Appl. No.: 19/439,989

(22) Filed: Jan. 5, 2026

Related U.S. Application Data
(63) Continuation of application No. PCT/CN2023/106037, filed on Jul. 6, 2023.

(51) Int. Cl. H04L 41/5041; H04W 60/00

(52) U.S. Cl. CPC H04L 41/5041; H04W 60/00

(57) ABSTRACT

The present application relates to, for example, a method, apparatus, and system for providing a confederation network in a communication system. An example method is performed by a plurality of network functions. The method includes: establishing and managing, by a first function of the plurality of network functions, a confederation involving a plurality of network modules, the confederation providing a service via cooperation of the plurality of network modules, where the plurality of network functions are established using networked computing resources and are operatively coupled together. The method further includes generating, by a plurality of second functions of the plurality of network functions, a record of actions taken by a respective one of the plurality of network modules, where each of the plurality of second functions is integrated into said respective one of the plurality of network modules.

### CROSS-REFERENCE TO RELATED APPLICATIONS

This application is a continuation of International Application No. PCT/CN2023/106037, filed on Jul. 6, 2023, the disclosure of which is hereby incorporated by reference in its entirety.

### TECHNICAL FIELD

This application pertains generally to the field of networked communication systems and in particular to confederation networks in which multiple entities, potentially with different interests, cooperate to provide services.

### BACKGROUND

Current wireless communication systems (also referred to as wireless systems), such as 5^{th} Generation (5G) systems as defined by the 3^{rd} Generation Partnership Project (3GPP), are designed to provide connectivity services. It is anticipated that future wireless systems (e.g., 6^{th} Generation (6G) systems as defined by the 3GPP) will go beyond connectivity provisioning to offer various new services, such as artificial intelligence and data management services. It is also anticipated that the future wireless system may be operated by multiple parties, for example, with different parties operating a different portion of the wireless system to offer certain services. These services may be provided for the system's (e.g., operating party's) internal use or for an end customer's use. The different parties, such as telecommunication operators and vertical service providers, may have their own interests and agendas, which may potentially compete or conflict with the interests and agendas of others.

However, current wireless systems and infrastructure require further development to support the above scenario and comparable scenarios. Such development is not straightforward and can require solving of a variety of technical and design problems.

Therefore, there is a need for a method, apparatus, and system for providing network services, that obviates or mitigates one or more limitations in the prior art.

This background information is intended to provide information that may be of possible relevance to the present disclosure. No admission is necessarily intended, nor should it be construed, that any of the preceding information constitutes prior art against the present disclosure.

### SUMMARY

Embodiments of the present disclosure provide for a method, apparatus and system for providing a confederation network in a communication system. The confederation network involves multiple independent parties or their associated network modules, which may have competing or conflicting interests, operating together to provide a defined overall service.

Various embodiments may provide for a CONET Architecture definition including multiple (e.g., three) layers and basic logical functionalities and modules in each layer. Various embodiments may provide for interfaces between modules and CONET in the system. Various embodiments may provide for definition of CONET services. Various embodiments may allow for multiple possible mappings between player and groups in CONET. Various embodiments may provide for CONET deployment options to de-centralize confederation of multiple players. Various embodiments may provide for CONET at an XaaS level design and processing.

In accordance with an embodiment of the present disclosure, there is provided a system, e.g., in a computer network. The system may include a plurality of network functions established using networked computing resources and operatively coupled together. The network functions include a confederation control function (CCF) also referred to as a first function, a plurality of agent functions also referred to as second functions, and a surveillance control function (SCF) also referred to as a third function. The CCF is configured to establish and manage a confederation involving a plurality of network modules, where the confederation provides a service via cooperation of the plurality of network modules. Each of the plurality of agent functions is integrated into a different respective one of the plurality of network modules and is configured to generate a record of actions taken by this respective one of the plurality of network modules. The SCF is configured to deploy and communicate with the plurality of agent functions, and to perform surveillance of actions taken by the plurality of network modules. The surveillance is based at least in part on the records of actions.

As used herein, a confederation provides a service, while network modules also provide their own respective services. The service of the confederation arises at least in part from the services provided by the constituent network modules. For clarity, where required, the services of the network modules are referred to as sub-services, to distinguish them from the service of the confederation.

In some embodiments, the CCF is further configured to direct a blockchain service to establish a blockchain to support the service, and to direct the plurality of modules to utilize the blockchain for providing the service. Directing may involve instructing, requesting, causing, initiating, or the like, for example by sending a message. In some further embodiments, utilizing the blockchain includes posting log records to the blockchain, posting action requests to the blockchain, or both.

In some embodiments, the CCF is further configured to perform or trigger authentication and/or authorization of each of the plurality of network modules, and to admit each of the plurality of network modules to the confederation only after successful completion of the authentication and/or authorization.

In some embodiments, the CCF is further configured to obtain information indicative of location of each of multiple network modules and sub-services provided by each of the multiple network modules, and to select the plurality of network modules from the multiple network modules to form the confederation based on the obtained information. In some embodiments, e.g., in more detail, the CCF is further configured to register the plurality of network modules in addition to further network modules, where registration includes obtaining information indicative of location of and sub-services provided by each of the plurality of network modules and the further network modules. In some embodiments, the CCF is further configured to select the plurality of network modules to form the confederation based on information obtained during the registration. In some embodiments, the CCF is further configured to establish one or more contracts to be followed by the plurality of network modules in providing the service, the one or more contracts defining rules to be followed by the plurality of network modules. In some further embodiments, selecting the plurality of network modules includes selecting (or searching for and discovering) at least one of the network modules based on requirements of the service.

In some embodiments, the CCF provides or is operatively coupled to a registration authority (RA) configured to verify identify of the plurality of network modules and to obtain and distribute certificates authenticating each of the plurality of network modules. The certificates are obtained from a certification authority (CA) operatively coupled to the registration authority, and the certification authority operates using a cryptographic certification system.

In some embodiments, the confederation includes a main group and at least one sub-group. The main group includes the CCF, the plurality of agent functions and the SCF, and each sub-group includes two or more of the plurality of network modules. In some further embodiments, each sub-group contains a minimal subset of the plurality of network modules which are required to implement an associated function of the service, the associated function being less than an entirety of the service. In some embodiments, the main group and each of the at least one sub-groups interact (indirectly) through the CCF. In some embodiments, the main group is operated using a main consortium blockchain and each of the at least one sub-groups is operated using a different respective further consortium blockchain. In some embodiments, at least one of the plurality of agent functions is further operated using a different respective private blockchain.

In some embodiments, the CCF is further configured to establish one or more contracts to be followed by the plurality of network modules in providing the service. The contracts define one or more of: rules for performing read or modify operations on status database information; and rules for performing service logic and/or execution operations. In some further embodiments, the confederation includes a main group and at least one sub-group as noted above. Each of the main group and the sub-groups may be associated with a different respective one of the one or more contracts, such that all members of the main group are associated with a same one of the one or more contracts, and all members of each of the sub-groups are associated with another respective same one of the one or more contracts. In some further embodiments, the one or more contracts are independent of data status and CONET group. In some further embodiments, the contracts indicate sub-services that must be provided by different ones of the plurality of network modules.

In some embodiments, the SCF maintains or manages maintenance of a record of actions performed by each of the plurality of network modules and provides the record of actions to all of the plurality of network modules. In some further embodiments, the SCF manages maintenance of the record of actions performed by: directing a blockchain service to establish a blockchain to maintain the record of actions, and directing the plurality of modules to record actions taken thereby using the blockchain.

In some embodiments, the system is further configured to maintain and manage the CCF, the SCF and the plurality of agent functions.

In some embodiments, the system is further configured to receive and respond to queries from government or regulatory authority agencies, at least in part by providing information obtained by the SCF to the government or regulatory authority agencies upon determining that it is lawful to do so.

In some embodiments, the plurality of network modules and the plurality of network functions all belong to a same first domain of the computer network. In such embodiments, the system may further include a second plurality of network functions, a second CCF also referred to as a fourth function, a second plurality of agent functions also referred to as fifth functions, and a second SCF also referred to as a sixth function. The second plurality of network functions may be established using networked computing resources and operatively coupled together. The second plurality of network functions all belong to a same second domain of the computer network different from the first domain and include the second CCF, the second plurality of agent functions, and the second SCF. The second CCF is configured to establish and manage a second confederation involving a second plurality of network modules belonging to the second domain. The second confederation provide the service or a second service via cooperation of the second plurality of network modules. The second confederation may contribute to providing the service which is also provided by the first confederation. The second plurality of agent functions are each integrated into a different respective one of the second plurality of network modules and configured to generate a second record of actions taken by the respective one of the second plurality of network modules. The second SCF is configured to deploy and communicate with the second plurality of agent functions, and to perform surveillance of actions taken by the second plurality of network modules, the surveillance based at least in part on the second records of actions. Third, fourth and further sets of network functions may be similarly provided.

In some embodiments, the CCF is further configured to maintain regular communicative contact with each of the agent functions to detect abnormal functioning or disconnection thereof.

In some embodiments, the CCF performs some or all of: establishing the confederation; defining a respective list of actions to be performed by each of the plurality of network modules; determining rules to be followed by the plurality of network modules; defining and implementing a procedure to be followed by the plurality of network modules to join the confederation; defining and implementing a procedure to be followed by the plurality of network modules to leave the confederation; and defining and facilitating interaction between the plurality of network modules and one or more blockchains.

In some embodiments, one of the plurality of network modules is a blockchain network module configured to manage blockchain execution, and the CCF is further configured to facilitate interaction between one or more of the plurality of network modules and the blockchain network module.

In some embodiments, the CCF is further configured to establish two or more sub-groups each including two or more of the plurality of network modules. In some further embodiments, the CCF is further configured to associate each of the two or more sub-groups with a different respective one of two or more contracts, such that all members of a same one of the sub-groups are associated with a same one of the two or more contracts. In some embodiments, the CCF is further configured to obtain profile information from each of the plurality of network modules. In some embodiments, the CCF is further configured to establish mappings between each one of the two or more sub-groups and a respective blockchain for the one of the two or more sub-groups. In some embodiments, the CCF is further configured to facilitate cross-chain interactions between two or more of the respective blockchains upon determining a requirement for the cross-chain interaction.

In some embodiments, each of the network modules provides a different respective role in the service, the role provided as a sub-service, and each of the network module further includes a task control function for managing provision of the sub-service and a plurality of processing functions for provision of the sub-service.

In accordance with other embodiments, there is provided a method including, for example by a plurality of network functions established using networked computing resources and operatively coupled together: by a confederation control function (CCF), establishing and managing a confederation involving a plurality of network modules, the confederation providing a service via cooperation of the plurality of network modules; by a plurality of agent functions, each integrated into a different respective one of the plurality of network modules, generating a record of actions taken by the respective one of the plurality of network modules; and by a surveillance control function (SCF), deploying and communicating with the plurality of agent functions, and performing surveillance of actions taken by the plurality of network modules, the surveillance based at least in part on the records of actions.

Other aspects of the above method may be provided similarly to aspects of the system as already described above.

In accordance with an embodiment of the present disclosure, there is provided a computer program product comprising a (e.g., non-transitory) computer readable medium having statements and instructions stored thereon which, when executed by one or more computer processors, cause the computer processors to perform the method as set forth above.

Embodiments have been described above in conjunctions with aspects of the present application upon which they can be implemented. Those skilled in the art will appreciate that embodiments may be implemented in conjunction with the aspect with which they are described, but may also be implemented with other embodiments of that aspect. When embodiments are mutually exclusive, or are otherwise incompatible with each other, it will be apparent to those skilled in the art. Some embodiments may be described in relation to one aspect, but may also be applicable to other aspects, as will be apparent to those of skill in the art.

### BRIEF DESCRIPTION OF THE DRAWINGS

Further features and advantages of the present disclosure will become apparent from the following detailed description, taken in combination with the appended drawings, in which:

FIG. 1 illustrates a system including service modules, management and control modules and infrastructure modules, in accordance with embodiments of the present disclosure.

FIG. 2 illustrates a system for providing or managing a confederation, in accordance with embodiments of the present disclosure.

FIG. 3 illustrates components for registration and certification of service modules of a confederation, in accordance with embodiments of the present disclosure.

FIG. 4 illustrates example relationships between groups or sub-groups of a confederation, in accordance with embodiments of the present disclosure.

FIG. 5 illustrates multiple controllers interoperating and belonging to different network domains, in accordance with embodiments of the present disclosure.

FIG. 6 illustrates operations of a confederation network controller, in accordance with embodiments of the present disclosure.

FIG. 7 illustrates operations of a confederation network controller and a blockchain module, in accordance with other embodiments of the present disclosure.

FIG. 8 illustrates an example of operations of a confederation network controller and associated network devices, in accordance with embodiments of the present disclosure.

FIG. 9 illustrates another example of operations of a confederation network controller and associated network devices, in accordance with embodiments of the present disclosure.

FIG. 10 illustrates a computing device that may perform computing or related operations according to embodiments of the present disclosure.

It will be noted that throughout the appended drawings, like features are identified by like reference numerals.

### DETAILED DESCRIPTION OF ILLUSTRATIVE EMBODIMENTS

As used herein, the term “anything-as-a-service,” i.e., “XaaS” can reflect the concept as it has been proposed in the computer networking industry. For example, XaaS can be conceptualized as a generalization of software-as-a-service or infrastructure-as-a-service concepts. XaaS can leverage cloud computing and device virtualization concepts, coupled with a service model to deliver a variety of functionalities. According to embodiments of the present disclosure, XaaS can describe, for example, that the functionality of an arbitrary module disclosed herein can be provided as a service to another module or an external entity, such as a customer. The phrase “as service” is used herein to be synonymous with “as a service.”

An open system architecture may refer to a design approach in which systems (e.g., modules) are interoperable and interconnectable with one another, generally without requiring retrofit or redesign. An open system architecture is one approach for achieving a modular design in which modules are configured to be interoperable. An open system architecture can involve modules which are responsive in a known manner to known inputs, for example to perform actions or provide responses to queries, inputs or stimuli in a predictable (possibly standardized) manner. Modules in an open system architecture can provide functionalities as a service in that they respond to inputs or stimuli in a particular way, thus providing such functionalities. A service may be provided by a server to a client, and thus the “as service” model may involve a server-client model.

An open system architecture may be used to provide any one or more of a variety of services, centric to any one of a variety of entities such as providers or users, to support various operating scenarios. The architecture may further provide for a scalable system, allowing for dynamically enabling or delivering a variety of currently known and to-be-determined services without necessarily modifying or redesigning the overall system architecture.

Under the scope of increasing societal digitization, a universal and ultra-high-performance Information and Communication Technology (ICT) infrastructure is considered as an important foundation to support demands from individual users, as well as from so-called vertical industries. 3G networks attempted to capture the Internet market by providing certain services, but limited these to the technological domain of telecommunication operators, hence largely failing to attract the Internet players. 4G networks corrected this through an efficient implementation of high-speed IP packet delivery, opening up the service space. 5G networks provided a successful beginning for integrating new types of network usage and new user communities, and provided a beginning for industry use cases and players. The philosophy underlying 5G development might be roughly summarized through connecting more and different types of users better. However, for the users, service-level properties are important and 5G as a connecting network or access network cannot fully control these. This identifies a gap between the aspirations of 5G and the actual technical specification.

The 6G network might be characterized by a high degree of heterogeneity in terms of participating players, which includes not only conventional telecommunications operators, but also new relevant players such as vertical operators. Ecosystem Openness of future networks is relevant from technology aspect as well as from social and commercial aspects. Furthermore, a trustworthy and secure interactions among the players should be provided in the multi-player ecosystem, and the data flowing and usage among the players raises the concern on security and privacy protection. The 6G network should have native support for privacy protection.

Future networks may also be expected to play more and more important role in future society and become an attractive industry. A more open business environment and eco-system regarding development, deployment, operation, control and management of wireless network can be expected. A variety of players in this industry will play different roles. Exclusively control and management of wireless networks by operators is facing huge challenges. Embodiments of the present disclosure may provide or support a confederation network (CONET) which may provide confederation services for multiple parties (players) to address these challenges effectively.

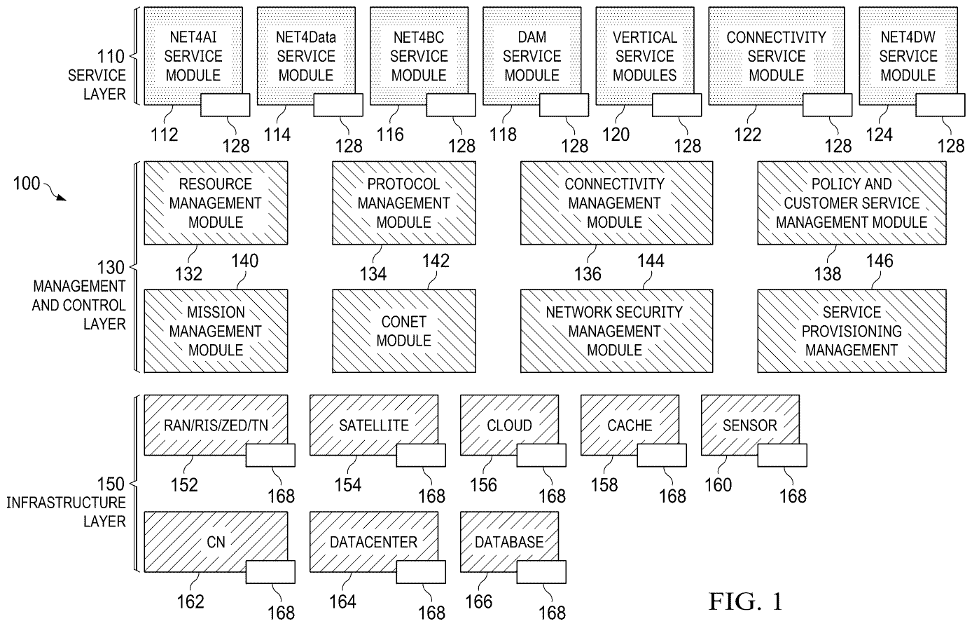

Embodiments of the present disclosure provide for a method, apparatus and system supporting CONET operation. Such embodiments may facilitate trust and cooperation between different parties of the confederation, which may be represented or implemented using respective network modules. Examples of network modules are described with respect to FIG. 1. The modules cooperate to collectively provide an overall service to one or more clients. Embodiments incorporate a variety of interoperating mechanisms, including a mechanism to establish and manage the confederation and a mechanism to perform surveillance of network modules in the confederation. The surveillance may be performed in order to facilitate trust. Establishing and managing the confederation may include a variety of actions such as, but not necessarily limited to: establishing contracts to be followed by the network modules (or associated entities) in order to deliver the overall service; establishing a blockchain to support the service; discovering network modules to join the confederation; admitting and registering network modules to the confederation; and appropriately grouping network modules. Embodiments may also include facilitating operation of modules including interactions, for example via blockchain. Surveillance outcomes may also be recorded, for example via blockchain. Embodiments provide for agents incorporated into the network modules. The agents facilitate surveillance for example by recording actions of the network modules and providing information indicative of the actions to the surveillance mechanism or an associated blockchain. Embodiments may be provided by operatively coupling multiple separate network functions, including a confederation control function (CCF) configured to perform confederation establishment and management, agent functions, and a surveillance and control function (SCF) configured to perform surveillance and communicate with the agent functions.

FIG. 1 illustrates an (e.g., X-centric) architecture provided in accordance with an illustrative embodiment of the present disclosure. The architecture 100 includes a service layer 110, a management and control (M/C) layer 130, and an infrastructure layer 150. Different layers may provide different services. Services of each layer are examples of different types of XaaS services. Accordingly, an architecture having three different layers, with XaaS modules (also referred to generally as network modules) in each layer, is provided, which may facilitate openness and extensibility.

The service layer 110 includes one or a plurality of service modules. Service modules can be included or excluded as required for a particular operating scenario. As new service modules are developed, they can be included into an existing architecture or implementation of the network.

By way of example, FIG. 1 illustrates a variety of possible service modules. These examples are not necessarily intended to be limiting. Indeed, embodiments of the present disclosure are capable of hosting service modules which have not yet been conceptualized, and such modules may be added as they are developed or required. Similarly, modules may be omitted where not required. A NET4AI module 112 provides a NET4AI service; a NET4Data module 114 provides a NET4Data service; a NET4BC module 116 provides a NET4BC service; a DAM module 118 provides a DAM service; one or more vertical modules 120 provide one or more associated vertical services; a connectivity service module 122 provides a connectivity service; and a NET4DW service module 124 providing a NET4DW service. Descriptions of each of these modules are provided below. Each module can be provided (e.g., operated) by a different party, or multiple modules can be provided (e.g., operated) by the same party. A service module (e.g., any of the above-mentioned service modules) may provide or offer a service (e.g., NET4AI service, NET4Data service, NET4BC service, DAM service, vertical services, connectivity service) to an end customer (user), to one or more M/C modules in the M/C layer 130, or to other service modules in the service layer 110, or a combination thereof. Service modules can provide services to other service modules in a substantially arbitrary chain or web of interconnections. In various embodiments, any given service module can potentially be provided as a service to any other given service module (in the same layer or another layer) or to an external user or customer.

The NET4AI (network for artificial intelligence) service provided by the NET4AI module 112 may be described as follows. The NET4AI service provides some or all of: artificial intelligence (AI) model customization and management, AI model distribution and parallelization, AI model training, and inferencing optimization. The NET4AI module facilitates providing AI as a service. AI as a service can refer to a service by which AI or machine learning resources can be provided for use by an end user or other service module or any of the M/C modules 130.

The NET4Data (network for data) service provided by the NET4Data module 114 may be described as follows. The NET4Data service provides some or all of: data upload and data storage, data access control and data protection. The NET4Data module facilitates providing data storage (e.g., cloud storage) as a service. Data storage as a service may be deployed to handle an end user's data or the data of another one of the service modules 110 or any of the M/C modules 130. The NET4Data service may store data in one or more computer memories, and may manage features such as data integrity and backup, data redundancy, data retrieval speed optimization, etc. The NET4Data service may also provide for data sharing.

The NET4BC (network for blockchain) service provided by the NET4BC module 116 may be described as follows. The NETBC service provides generic management and control of block chain operations. The NET4BC service handles block data and enables block chain as a service.

The NET4BC service may be a platform configured to initialize blockchains, generate blockchain blocks (records), verify blockchain blocks, and store blockchain blocks. Blockchain operation can proceed in a variety of ways as will be readily understood by a worker skilled in the art, to provide a (e.g., public) record of transactions, actions or events.

The DAM (data analytics and management) service provided by the DAM module 118 may be described as follows. The DAM service provides some or all of: data collection and verification, data privacy protection, data analysis, and data delivery. The DAM service handles all types of data and enables data analytics and management as a service. The DAM service may also provide for data sanitization.

Vertical services provided by the vertical module(s) 120 may include a vehicle to everything (V2X) service, an Internet-of-Things (IoT) service, a metaverse (digital world) service, etc. Handling vertical (e.g., V2X, Metaverse) customer's data traffic. A vertical service may generally be described as a service which is associated with a vertical service provider. A vertical service provider may provide one or more specialized products or services in a particular niche. Examples of vertical service niches include banking, manufacturing, education, real estate, government or law.

The connectivity service provided by the connectivity service module 122 may facilitate provisioning of data connectivity between devices or endpoints. For example, data connectivity may be provisioned between a device and a data network (DN), between two application services or servers, or the like. The connectivity service may facilitate providing data connectivity as a service. In various embodiments, the connectivity service may handle end user's data traffic, such as voice traffic or application layer data. The connectivity service may include a 6G connectivity service. In some embodiments, the connectivity service module 122 is integrated with the mission management module 140. For example, the connectivity service module 122 may be integrated within the mission management module 140 such that the mission management module 140 provides the connectivity service.

The NET4DW service module 124 provides digital world functionality and related services. The digital world functionality and related services (i.e. the digital world services in short) provide a capability to construct, control and manage a digital world. The digital world is defined as a digital realization of the physical world. Digital world, for example Metaverse, provides an interactive, multi-user environment which is intended to emulate various physical aspects of the real world. Sensors may be used to obtain digital world participant data, and the digital world may react to this sensor input, for example by providing corresponding outputs to the participant or other remote participants, in order to make the user experience immersive. The NET4DW service module may handle digital world participant data in order to facilitate such an experience, obtain and utilize network resources to facilitate the experience to a desired quality, manage participation, direct user experiences, etc.

As used herein, a service provided by a service module in the service layer 110 may be referred to as an XaaS service. Because the service is provided at the service layer 110, it is referred to as a service layer XaaS service.

A service module may include one or multiple network functions. A service module may provide an associated service using these network functions. When the service module includes only one network function, the service module may be equated with (or may be) this included network function.

In various embodiments, a service has its own data process which is implemented by some or all of the one or multiple network functions of the service module. Data processes may include computing or data processing, data storage, block creation, data de-privacy operations, etc.

The M/C layer 130, (which may also be referred to as the control and management (C/M) layer) includes one or multiple M/C modules.

By way of example, FIG. 1 illustrates a variety of possible M/C modules. These examples are not necessarily intended to be limiting. A resource management (RM) module 132 provides a RM service. A protocol management (PM) module 134 provides a PM service. A connectivity management (CM) module 136 provides a connectivity service. A policy and customer service management (CSM) module 138 provides a policy and CSM service. A mission management (MM) module 140 provides a MM service, where missions are as described elsewhere herein. A confederation of networks (CONET) module 142, which is associated with embodiments of the present disclosure, provides a CONET service. A network security management (NSM) module 144 provides a NSM service. A service provisioning management module 146 provides a service provisioning management service. Each M/C module can be provided by a different party. One or more M/C modules can be provided by the same party. An M/C module (e.g., any of the above-mentioned M/C modules) may provide an M/C service (e.g., RM service, PM service, CM service, CSM service, CONET service, NSM service) to an end customer (user) (which may be an external customer or user), to one or more infrastructure modules in the infrastructure layer 150, to one or more of the service modules in the service layer 110, to other M/C modules in the M/C layer 130, or the like, or a combination thereof.

The RM service provided by the RM module 132 may be described as follows. The RM service may manage resources in a static way or a dynamic way. The managed resources may include resources provided by the infrastructure layer, such as wireless resources, wireline resources, computing resources, storage resources, and sensing resources. Managing resources may include managing and controlling network slicing and data routing. The RM service may provide a capability of life-cycle management of one or more network slices and over-the-air resource assignments to wireless devices.

The PM service provided by the PM module 134 may be described as follows. The PM service may provide software-define protocol functionalities, such as packet processing function chain and configuration, protocol stack selection and configuration, protocol parameter tuning and optimization, or the like, or a combination thereof. This PM service may also be referred to as a software defined protocol (SDP) service. The PM service may provide a capability to design service customized protocol stacks for identified interfaces. The protocol stacks may be pre-defined for on-demand selection. The protocol stacks may be designed on demand.

The CM service provided by the CM module 136 may be described as follows. The CM service may provide connection management, mobility management, handover, path switching, registration management, paging, power saving management, or the like, or a combination thereof.

The CSM service provided by the CSM module 138 may be described as follows. The CSM service may provide authentication, identification (ID) management, key management (traffic protection), authorization, service level agreement (SLA) management, SLA enforcement, policy/rule/regulation assurance, installment (charging), or the like, or a combination thereof. SLA may refer to a service level agreement between any two or more of a variety of parties. For example, an SLA may be between parties operating in the service layer, parties operating in the M/C layer, parties operating in the infrastructures, or the like, or a combination thereof. Each of these parties may have one or multiple roles as described elsewhere herein for example with respect to described X-centric scenarios.

The MM service provided by the MM module 140 may be described as follows. The MM service may transform the data processes of one or more relevant service modules in the service layer to a mission, for example upon request. The MM service (more precisely, the MM module providing the MM service) may manage (e.g., establish, modify and configure) communication tunnels between the service data planes of the relevant service modules to support the mission. In some embodiments, the MM service (more precisely, the MM module 140 providing the MM service) may invoke (i.e. use) the connectivity service (provided by the connectivity service module 122) to manage (e.g., establish, modify and configure) communication tunnels between the service data planes of the relevant service modules to support the mission, and the connectivity service (more precisely, the connectivity service module 122 providing the connectivity service) manages the communication tunnels correspondingly. Missions may be as described elsewhere herein, for example in relation to cross-layer, cross-service interactions. A mission may be a service provided to customers. A mission may be a type of service which is provided by a single service or using contributions from multiple services. The MM service provides a capability to program provisioning of XaaS services at the service layer to provide mission services. In some embodiments, the MM module 140 is integrated with the connectivity service module 122, for example, integrated within the connectivity service module 122 such that the connectivity service module 122 provides the MM service.

The CONET service provided by the CONET module 142 may be described as follows, according to some embodiments of the present disclosure. The CONET service may provide or facilitate trust consortium establishment, consortium member joining or leaving, block chain management including creation, update and deletion. The CONET service may also be referred to as a block chain for network (BC4NET) service. The CONET service may involve or facilitate confederation formulation, mutual authentication, mutual authorization among partners and negotiation of agreement on recording and retracing of selected actions performed by such partners. This may be performed in order to provide for a trustworthy environment of system operations.

The NSM service provided by the NSM module 144 may be described as follows. The NSM service may provide or facilitate equipment operation security risk detection, network operation security risk detection, network operation security risk prediction, or the like, or a combination thereof. The NSM service may also be referred to as security for network (SEC4NET) service. The NSM module 144 provides network security as a service. This may provide a capability for infrastructure owners to detect potential security risks of or to their infrastructure assets, for example.

The service provisioning management module 146 provides a capability of control and management of service access by customers and provisioning of requested services. This capability may be provided using unified mutual authentication, authorization and policy, key management, QoS assurance and charging between any pair of XaaS service provider and customer. Customers in this sense may include end customers in the physical world, and digital representatives in the digital world, or both.

In various embodiments, an M/C service provided by an M/C module may be an XaaS service. Because the service is provided at the M/C layer, it may be referred to as an M/C layer XaaS service.

In various embodiments, the M/C module comprises one or multiple network functions and provides the M/C service using these network functions. When providing the M/C service, the M/C module may utilize service-layer XaaS services. When the M/C module includes only one network function, the M/C module may be equated with (or may be) this network function.

In various embodiments, the M/C service has its own signaling process which is implemented by some of the one or multiple network functions of the M/C module. The signaling processes may include, for example, management signaling, control signaling, or the like, or a combination thereof.

The infrastructure layer 150 includes one or more infrastructure modules. The infrastructure modules may provide or offer diversified infrastructure resources. The infrastructure modules may include terrestrial communication modules 152. Examples of terrestrial communication modules include a radio access network (RAN) module, a reconfigurable intelligent surfaces (RIS) module, a zero energy devices (ZED) module, and a transport network (TN) module. The infrastructure modules may include non-terrestrial communication modules 154, such as satellite network communication modules. The infrastructure modules may include cloud modules 156, such as data center networks. The infrastructure modules may include caching modules 158, such as caching nodes. The infrastructure modules may include sensor modules 160, such as sensor nodes or sensor networks. Also illustrated as part of the infrastructure layer 150 are a core network (CN) infrastructure module 162, a datacenter infrastructure module 164 and a database infrastructure module 166. The RAN infrastructure module 152 and the core network (CN) infrastructure module 162 may interoperate as complementary parts of one or more wireless networks. The datacenter infrastructure module 164 may operate similarly to the cloud module 156, to provide datacenters or related capabilities. The database infrastructure module 166 may similarly provide for database-specific capabilities, for example in the form of one or more databases responsive to database queries or data storage operations.

Each infrastructure module can be provided by a different party, or multiple infrastructure modules can be provided by the same party. Providing may include providing and operating a module, or operating an already provided module. An infrastructure module (e.g., any of the above-mentioned infrastructure modules) may provide an infrastructure service (in the form resources) to an end customer (user), to the service layer or module thereof, to the M/C layer or module thereof, to other infrastructure modules in the infrastructure layer, or the like, or a combination thereof. The infrastructure service provided by an infrastructure module may be referred to as an infrastructure layer XaaS service. Each infrastructure module, or the plurality of infrastructure modules, may be provided by a single provider or by multiple providers.

As also illustrated in FIG. 1, each service module in the service layer 110 may include or be operatively coupled to its own respective service M/C plane component 128. Similarly, each infrastructure module in the infrastructure layer 150 may include or be operatively coupled to its own respective infrastructure M/C plane component 168. The M/C plane components 128, 168 may be dedicated control functions for the module to which it is associated.

The modules of the M/C layer 130 may be provided and deployed by using network slicing. These modules may also utilize (e.g., via network slicing) resources provided by the infrastructure layer.

The use of modules, such as service modules, M/C modules and infrastructure modules, may facilitate a customizability of the architecture as disclosed herein. Modules can be provided on an as-needed basis, with unnecessary modules omitted. This can streamline and simplify implementation of the architecture. Furthermore, as future services become available, they can be encapsulated in new modules and added on an as-needed basis. Each module may be substantially self-contained and interoperate with other modules or system components using a defined interface or protocol. Thus, adding a module or removing a module can be done without necessarily reconfiguring the other modules. This facilitates a ready reconfigurability of the architecture.

Different system modules as described above (e.g., service modules, M/C modules, infrastructure modules) may be provided by different parties. Parties can be business entities, “players”, etc. A business entity can be focused on providing one or more products or services, for example communications or computing infrastructure, software services, applications, utilities, consulting, government, or the like, or a combination thereof. Three different roles that can be taken on by a party include: service layer XaaS provider, M/C layer XaaS provider, and infrastructure layer XaaS provider. A party providing at least one service module at the service layer takes on the service layer XaaS provider role. A party providing at least one M/C module at the M/C layer takes on the M/C layer XaaS provider role. A party providing at least one infrastructure module takes on the infrastructure layer XaaS provider role. A party may provide modules at more than one layer, thus taking on multiple roles.

From a system design perspective, an appropriate number of players or modules should be defined. If the player granularity is too small or the number of players is too large, the network will be too complex and the system efficiency will be too low. This principle may be applicable to the total available number of network modules, or to the number of network modules in a confederation, or both.

The confederation formed according to embodiments of the present disclosure can involve two, three or more or the network modules described above with respect to FIG. 1, or other network modules. The CONET module 142 may implement embodiments of the present disclosure. Embodiments may utilize blockchain services provided by the NET4BC service module 116. By way of non-limiting example, embodiments below are described in which a confederation includes some or all of: a NET4AI module, a NET4Data module, a DAM module, and a NET4DW module. The types of modules forming a confederation may depend on the requirements of the service(s) provided by the confederation.

Embodiments of the present disclosure provide for an open and trustful environment, architecture or ecosystem for providing services using a communication network. This may include infrastructure deployment, operation, control and management of wireless systems. A variety of players in this ecosystem may play different roles.

According to embodiments, CONET defines a decentralized confederation and an open environment with multiple players who participate and exit freely. When players are in the confederation, they can contribute to provisioning of connectivity services to business customers and to end-point entities of business customers. Embodiments facilitate the confederation by supporting self-interested, distrustful players to take on roles and establish interactions among each other through business models and service requirements in a trustful environment.

Embodiments provide for unified treatment of customer services and network services by control and management of wireless networks. Operations may include a specific type of services, on-demand internal and external exposure of information, or support of the optimization of the resource control and management of customer services in a sharable or dedicated manner, or a combination thereof. Customer services and network services may be treated in the same way by resource control and management functions in CONET.

Embodiments provide for a triggering of unified data services for single players or multiple players. Data services in the network can include one or both of: traditional data of each player; and shared data. Data may be uploaded to a blockchain as triggered by a controller of the present disclosure.

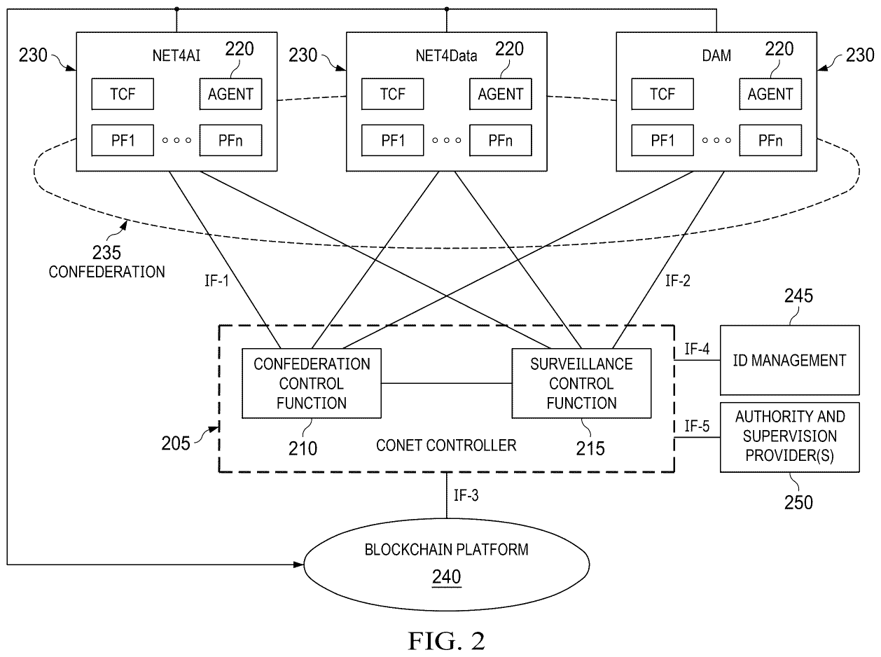

As illustrated in FIG. 2, embodiments of the present disclosure include a CONET Controller 205 and one or more CONET Agents 220. The CONET Controller 205 includes a Confederation Control Function (CCF) 210 and a Surveillance Control Function (SCF) 215. The CCF 210 and the SCF 215 may be operatively coupled together and may be implemented using the same or different networked computing hardware, such as servers, dedicated electronics, virtualized computing resources, etc. The agents 220 are similarly operatively coupled to the SCF 215 and may be implemented using networked computing hardware, for example hardware which is integrated with or operatively coupled to the network modules 230 within which the agents 220 are respectively integrated.

By way of non-limiting example, the network modules 230 include a Net4AI module, a Net4Data module, and a DAM module. These network modules 230 form a confederation 235. Each of the network modules 230 may provides a different respective role in the service. This role may be provided as a sub-service in accordance with the XaaS model. Each of the network modules 230 may include a task control function (TCF) for managing provision of the sub-service and a plurality of processing functions (PFs) for provision of the sub-service. At a development or deployment stage, the modules operate together as partners to join the confederation and provide a confederation chain profile. A confederation chain profile, in the context of the network modules 230 and also more generally, may specify information such as a module topology and performance requirements in relation to a blockchain.

Accordingly, in various embodiments, a system in a computer network is provided. The system includes a plurality of network functions established using networked computing resources and operatively coupled together. These network functions include the CCF 210, the SCF 215, and the agents 220. The CCF 210 is configured to establish and manage a confederation involving a plurality of network modules 230. The confederation may provide a service via cooperation of the network modules 230. The agent functions 220 are each integrated into a different respective one of the plurality of network modules. Each agent function 220 may be configured to generate and provide (e.g., to the SCF) a record of actions taken by said respective one of the plurality of network modules. The SCF 215 is configured to deploy and communicate with the agent functions 220. The SCF is also configured to perform surveillance of actions taken by the network modules, for example based at least in part on the records of actions provided by the agent functions 220. Agent functions 220 may operate as interface between their host network module, within which they are deployed, and the controller 205. At an operation stage, the agent functions are configured to collect action records of their host network modules and send surveillance reports to the controller 205.

The controller 205 may include a shared m/c layer to support XaaS services working together in a trusted environment. At a development/deployment stage the controller 205 facilitates network modules 230 to join the confederation 235 and controller 205, and notifies the blockchain (e.g., at Net4BC) with profile information to initialize a corresponding blockchain. At an operation stage, the controller 205 receives upload/surveillance action of upload/data update requests from entities (network modules) and notifies the blockchain.

In more detail, the CCF 210 may be configured to perform operations such as: establishing the confederation, allowing modules to leave or join the confederation, retrieving a confederation profile, triggering uploads to blockchain, managing authentication and/or authorization of modules, and interacting with control plane gateways. The confederation profile may indicate, for example a Group ID and a module ID for the confederation. This may involve message passing between the CCF 210 and the modules 230, the CCF retrieving information from the modules and sending queries or commands to the modules, performing logging, authentication and verification steps, and the like.

Also in more detail, the SCF 215 may be configured to perform operations such as: deploying (e.g., instantiating and configuring) and managing the agents 220, performing surveillance (e.g., monitoring and logging) of the network modules 230, and supporting lawful queries, such as requests for information made by authorities or regulatory agencies.

The CCF 210 interacts with the network modules 230 via a network interface indicated as IF-1. The SCF 215 interacts with the network modules 230, agents 220, or both, via a network interface IF-2. The controller CCF 210 interacts with a blockchain platform 240 via a network interface IF-3. For example, the CCF 210 may interact via IF-3 with the blockchain platform 240 in order to trigger the platform to provide services, for example by establishing a blockchain according to a confederation group request, and triggering the blockchain to perform logging operations, action uploads, etc. The CCF 210 may thus direct a blockchain platform 240 (also referred to as a blockchain service) to establish a blockchain to support the service, and to direct the network modules 230 to utilize the blockchain for providing the service. Subsequent utilizing of the blockchain by the modules 230 may include posting log records to the blockchain, posting action requests to the blockchain, or the like, or a combination thereof. At a deployment stage, the blockchain platform (e.g., Net4BC) initializes a blockchain according to a given chain profile. At an operation stage, the blockchain platform receives information such as transmission uploads or surveillance actions, generates blocks, verifies blocks and stores blocks. The blocks may be stored using NET4Data, for example.

The CCF 210 interacts with an ID management entity 245 via a network interface IF-4. The ID management entity 245 may be an authorization and authentication server, for example, which authenticates devices for example via cryptographic certificates, and provides authorization services, as would be readily understood by a worker skilled in the art. The interaction via IF-4 may support the CCF action of authentication and/or authorization of the network modules. Thus, the CCF 210 may be configured to perform or trigger authentication and/or authorization of each of the network modules 230, in cooperation with the ID management entity 245, and to admit each of the network modules 230 to the confederation 235 only after successful completion of said authentication and/or authorization.

The SCF 215 may interact with one or more authority and supervision providers (ASPs) 250 via IF-5. The ASPs may be or represent legal authorities, regulatory agencies, or the like. The ASPs may monitor activities of the modules or end users via reports from the SCF. The ASPs may be required to comply with certain regulations or laws prior to such monitoring. Thus, the SCF 215 may be configured to receive and respond to queries from government or regulatory authority agencies, at least in part by providing information obtained by the SCF to said government or regulatory authority agencies, upon determining that it is lawful to do so.

An entity (e.g., a PF) as used herein may refer to an instantiation of a module or function. For example a DAM02 entity may be an instantiation of a DAM network module. At an operation stage, an entity generates transactions and uploads action records to a blockchain, e.g., via Net4BC.

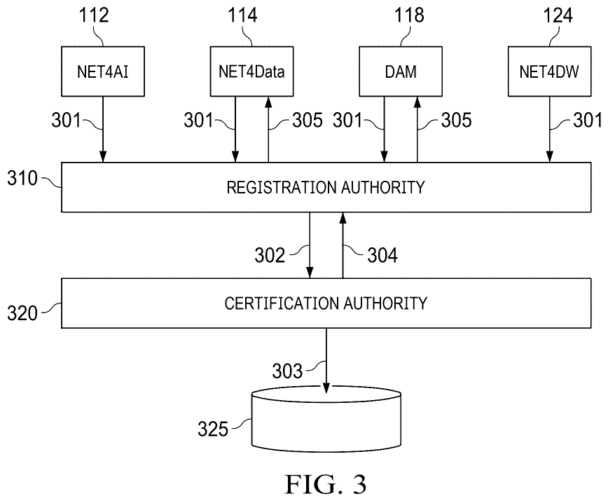

Embodiments of the present disclosure support establishment of a confederation of multiple independent players (network modules). By way of example, and with reference to FIG. 3, the network modules may include a Net4AI module 112 with the function of data AI analysis, a Net4Data module 114 with the function of data protection, a DAM module 118 with the function of data collection and de-privacy, and a Net4DW module 124. Confederation establishment may include, registration, discovery, or both. Initially (e.g., prior to confederation establishment), players register their own services with the CONET controller through the IF1 interface. The controller receives the players' information, which may include a requested service (to be provided by the controller) and entity location information.

The controller initiates an authentication of the players (modules), and after successful authentication, the controller saves the players' information in a Player Group Table or similar data structure. The controller also allocates a confederation group with contract(s) to the players which will form the confederation and operate together. Each confederation group has a unique identifier and the confederation group contract defines the normal and exclusive rules to be followed by the confederation group members. Normal and exclusive rules may define what players can do, for example. Registration to the player group table may be distinguished from registration to the confederation.

Registration to the player group table may involve identifying a pool of potential players from which a confederation may be formed. In this sense, the controller (e.g., the CCF portion) may register network modules, including obtaining information indicative of location of the modules, and services provided by the modules.

Allocating a confederation group can involve (e.g., by the CCF) selecting plural players (modules) from the identified pool, where the players have required characteristics and capabilities for forming the confederation. The selection is based on the acquired information obtained during the above-mentioned registration to the player group table.

Forming the confederation group may further involve (e.g., by the CCF) establishing one or more contracts to be followed by the players forming the confederation, at least in providing the service. Different player sub-groups may be associated with different contracts. The contracts define rules to be followed by the players. Establishing a contract with a module may include providing an indication of a contract to a module which, based on preconfiguration, may accept or reject the contract. The contract may be encoded with a selection of standard known rules (e.g., clauses, conditions, required actions, deliverables, etc.) which can be automatically accepted or rejected. Once accepted, the contract is used to guide operation of the modules in delivery of the service by the confederation.

If there are not enough confederation members to provide a required service, then the controller may search for, discover and add further players to the confederation or invite further players to join the confederation. The search and discovery may be based on requirements of the service, as well as capabilities already provided for by existing members. For example, suppose the controller only registers a Net4AI module and a Net4Data module, while a DAM module is not registered but is required for a service. In this case, the controller may filter location information and exclusive rules in the Player Group Table and initiate a DAM discovery operation. This may include searching for a DAM module listed in the Player Group Table and meeting certain location and other criteria. After the suitable DAM module is discovered and initiates to join the confederation (including registration, if required), the controller establishes the confederation group and notifies confederation group contract to each member. Search and discovery may be based on requirements for a certain type of player capability, a certain required capacity of resource such as computing, memory or communication resource, a certain location or set of locations of player presence, etc.

In various embodiments, the CCF is configured to authenticate players with a Registration Authority (RA) 310 and a Certification Authority (CA) 320. The RA 310 may perform player identity verification, and obtaining (from the CA) and distributing of corresponding player/member certificates. The RA may be part of the CCF or operatively coupled to the CCF. The RA may be configured to verify the identify of network modules and to obtain and distribute certificates authenticating each of the network modules. The CA 320 may generate, issue, and deregister member certificates as required. The RA may obtain the certificates from the CA. The CA 320 may maintain members' public keys, private keys, digital certificates and member certificate revocation lists (CRLs), and thus may operate using a cryptographic certification system as would be readily understood by a worker skilled in the art. The CA may manage the set of members in a Confederation Group and the mapping between members. The CA may be operatively coupled to a CA database 325 such as a key-value database. The CA database 325 stores public and private keys, digital certificates and CRLs. The CA database 325 can be located locally to the CA or may reside in an ID Management system accessed through the IF5 interface, for example.

Further with reference to FIG. 3, in operation(s) 301, players (e.g., Net4AI 112, Net4Data 114, DAM 118, Net4DW 124) send a registration request to the RA 310 which may be part of the CCF. In operation 302, after verifying the player identity, the RA 310 sends a certificate issuance request to the CA 320. In operation 303, the CA 320 issues certificates, and maintains the public and private keys, digital certificates, and CRLs of the players. In operation 304, the CA 320 sends the issued certificate to the RA 310. In operation(s) 305, The RA 310 sends the certificate to the players (e.g., Net4AI 112, Net4Data 114, DAM 118, Net4DW 124).

Embodiments of the present disclosure provide for groups in relation to a confederation. Different players (e.g., modules) are aggregated into one or more groups according to players definition. For example, each player can define its capabilities, limitations, conditions, or a combination thereof, and a group can accept or reject players according to such player-provided information. Groups may be allocated or configured according to a predetermined set of principles such as described below.

A first principle is that the group may be a hierarchical group. A hierarchical group includes multiple layers. Consequently, the players and the related services provided by the players may be divided into multiple sub-groups. Each sub-group may include multiple network modules. In addition, a main group which includes the CCF, the agent functions, and the SCF may be provided. Thus, the group may include a main group and at least one sub-group. The term “group” may refer to a main group or a sub-group, for example. Furthermore, a group may encompass one or more sub-groups, or a main group and at least one sub-group, or the like.

A second principle is that entities (e.g., network modules or network functions) providing closely coupled services or functions are placed in a same sub-group. Entities providing less closely coupled services or functions are then placed in different groups. This arrangement may be provided so as to achieve flexibility of management and operation. This arrangement may also provide for openness and multiple group scenarios.

A third principle is that a sub-group may be configured to consist of the minimum number of entities that can collectively implement a certain related function or functions. This arrangement may be provided so as to limit redundancy, e.g., by inhibiting more entities than is necessary to join a sub-group. That is, each sub-group may be configured to contain a minimal subset of network modules which are required to implement an associated function of the service. This associated function may be required to be less than an entirety of the service.

Based on the three principles above, the controller may configure a group as follows. Firstly, the main group maintains the indexes of all sub-groups, saves information about validation groups, and tracks groups with the controller. Secondly, each sub-group consists of multiple (e.g., five) player members or a subset of the multiple player members. A sub-group can be restricted so that it only manages a sub-set of services of the confederation, not all the services. Thirdly, the group combination of the confederation includes one main group and one or multiple sub-groups. The main group and sub-groups interact via the controller, for example via the CCF. The interaction may be invoked by contracts in each group.

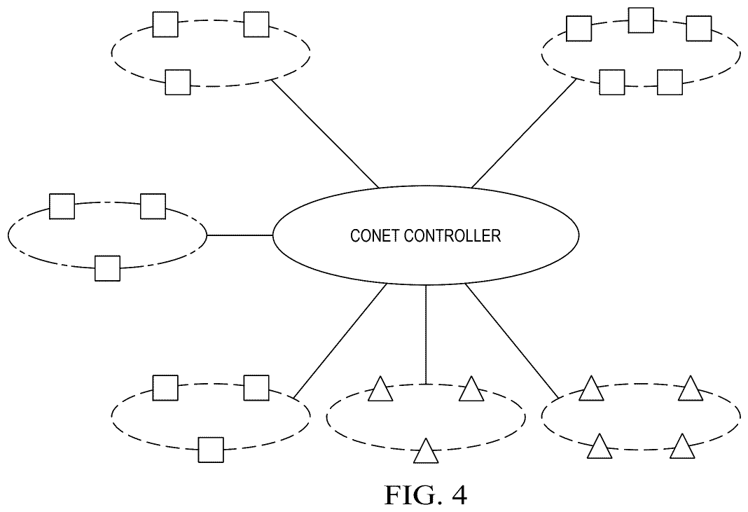

The relationship between CONET Group and the CONET chain is illustrated in FIG. 4. A main group is built up over and/or operated using a main consortium blockchain. Each sub-group is built up over and/or operated using a different respective sub-consortium blockchain. Services of one player (module) may be built up over a different respective private blockchain. The sub-consortium chain and the private blockchain may connect to the main consortium blockchain over a side chain.

As mentioned previously, embodiments of the present disclosure involve contracts between players (modules) in the confederation. Players form a confederation (or sub-group thereof) based on the services required to be completed together in order to fulfill the overall service of the confederation. A contract may be a convention of players within a confederation or sub-group on service logic and/or execution operations. As an example, contracts may establish rules for performing read or modify operations on key-value pairs and other status database information, rules for performing service logic and/or execution operations, or a combination thereof. It is also noted that contracts for players in the same sub-group are configured to be the same. Contracts for players in different sub-groups may be the same or different. Thus, each main group or sub-group may be associated with a different respective one of a plurality of contracts, such that all members of the main group are associated with a same one of the one or more contracts, and all members of each of the sub-groups are associated with another respective same one of the one or more contracts. Furthermore, in various embodiments, contracts are independent of the data status and confederation group. Referring to data status, different groups have different contracts, and each contract may define a role and actions of each player, player ID, action list, and role profile. Regarding the confederation group, the controller may interact with each player with a group ID and contract, where players in the same group have the same group ID and contract. The CCF may establish the contract(s), which are to be followed by the players or modules in providing the service or a portion of the service. Regarding data status, different groups have different contracts and each contract may define a role and actions of each player with player ID, action list, and role profile. Regarding confederation (CONET) groups, CONET may use CONET groups to aggregate different players to work together. Players in the same group have the same group ID and contract. CONET may interact with each player via group ID and contract.

An example contract for international charging, applied to players in a charging group or sub-group, is as follows. When a subscriber device makes a call in a roaming area, the roaming carrier and the subscriber device store a roaming agreement file, roaming communication call data records (CDRs) and billing data. The data is stored to the group or sub-group or an associated blockchain. The home carrier automatically interacts and parses all service data, such as protocols, bills and CDRs. In this case, the charging group or sub-group may include at least the subscriber device, the roaming carrier, and the home carrier, who are wireless service providers.

Another example contract, for digital identity authentication, applied to an identity authentication group or sub-group, is as follows. A unified authentication consortium across operators within a confederation group is formed. A distributed node network is created that can provide identity authentication services, such as mobile numbers, IP addresses, SIM card attributes, or the like, or a combination thereof.

Another example contract, for equipment management, applied to a device management group or sub-group, is as follows. Devices and inspection data are uploaded to the group or sub-group or an associated blockchain. Inspection data is automatically collected, stored in trusted storage, traced, and intelligently analyzed. A network equipment provider (NEP) can manage devices in a transparent and efficient manner.

Various embodiments of the present disclosure related to confederation network service definition are described as follows. Various embodiments pertain to confederation establishment of network functions, network modules, and services. In this respect, each of multiple players provides different services. For example, the Net4AI module provides a data AI analysis service, the Net4Data module provides a data protection service, and the DAM provides a data collection and de-privacy service. CONET supports confederation establishment services for these independent players, including registration and discovery. Players register their own services with CONET. During registration, CONET allocates a group with contract to the players which work together, obtains the request service and entity location information from the players, and saves information in a Player Group Table. The Player Group Table may be reused as services leave and join the Confederation Group. The Player Group Table may be reused for Confederation profile interactions in the Confederation Group.

For those players that miss initial registration, CONET selects the information that meets the player's discovery requirements as well as meeting the registration information in the Player Group Table and initiates the discovery service. For example, if a player or confederation requires the Net4AI service, CONET checks whether any registration record of a Net4AI module is available. If not, CONET initiates a discovery service, finds an AI service module, and establish a confederation group within the AI service. Accordingly, a discovery service may be employed, e.g., by the CCF, which searches for available network modules which are required for a confederation but which are not currently available. The search may be performed based on various criteria such as required capabilities, location, etc.

Embodiments of the present disclosure provide support for players to leave and join in a confederation group. In previous generations of networks, mobile network operators were dominant in the wireless communication industry ecosystem. However, more industry players are expected in 6G networks. These may be virtual network operators, service operators, etc. More types of customers are expected as well. The industry players and the working relationships among them may confederation groups. Embodiments of the present disclosure may facilitate openness and trust for a wide variety of such players to be substantially equally involved in certain types of network management and operation. Embodiments may facilitate players to leave and join in confederation groups, for example after consulting with the other group members for example via IF-1.

Embodiments of the present disclosure maintain the confederation contract for each group or sub-group, with exclusive rules that define which players or kinds of players or roles are allowed to work together as different players. For example, according to exclusive rules, the services of data de-privacy and data collection from DAM module should not supported by the same player. Thus, the contract may indicate services that must be provided by different ones of the plurality of network modules in a confederation.

Embodiments of the present disclosure provide support for confederation profile interactions in a confederation group. In a confederation group, different players have various profiles of topology, data type, security level, and performance request information. For example, topology information may be very important for data AI analysis service of the Net4AI module to use federated learning. Data type and security level information may also be important for the data protection service of the Net4Data module. Accordingly, embodiments may support a confederation profile interactions service, obtain profile information, translate confederation information and maintain profile records in a confederation profile table or other data structure. Embodiments may interact translated services information with a blockchain platform if these services are required to work together on the same blockchain. A blockchain platform achieves the knowledge of performance request, security level, chain topology from the CONET.

Embodiments of the present disclosure provide action surveillance of network functions, network modules, services, or a combination thereof. In previous generation networks, network modules are assumed to belong to the same operator and more attention is paid to monitoring UE behavior. However, in future networks, more players are expected in and action surveillance of players may be more important. Embodiments therefore provide an action surveillance service for each confederation group member. For example, a confederation group may include Net4AI, Net4Data and DAM modules, each of which have various actions of data AI evaluation, data upload and data de-privacy, respectively. In such an example, a controller (or SCF thereof) may employ a surveillance table or other data structure to maintain an action list for each player. That is the SCF may maintain or manage maintenance of a record of actions performed by each of the plurality of network modules and provides the record of actions to all of the plurality of network modules in a confederation. This may facilitate tracing each others' actions by confederation members. It is also noted that the feedback and transmission of actions have overheads, which affect the confederation performance. Therefore, embodiments may provide for maintenance and management services for action surveillance.

Embodiments of the present disclosure provide support to record actions taken by players in a confederation. This may involve triggering log and action to electronic storage, for example as part of a blockchain. The SCF may manage maintenance of the record of actions performed by: directing a blockchain service to establish a blockchain to maintain the record of actions, and to direct or trigger the players of a confederation to record their taken actions using the blockchain. After confederation establishment and action surveillance services, there are a potentially large number of logs and actions generated by each player or module of the confederation. Embodiments therefore provide a log and action storage method by which each member in the confederation group can trust each other. There are several methods usable to achieve this goal, but in some embodiments the generated log and action information are uploaded to a blockchain established for this purpose. Therefore, embodiments support services to trigger logs and actions upload to blockchain. Embodiments retrieve player profiles from modules such as Net4AI, Net4Data and DAM by use of a confederation profile interactions service. Embodiments then translate these player profiles to data volume, security level and performance requirements. According to data volume, security level and performance requirements, embodiments provide different modes to upload to the blockchain. For example, actions with high security level may upload metadata to blockchain. As another example, logs with large data volume may upload URL or other pointers or locators to the blockchain. As another example, logs and actions with high performance requirements may have read-only permission.

Embodiments of the present disclosure provide support for authentication and/or authorization of network modules and services. To adapt to the development of 6G, networks are likely to face an ecosystem in which different players interoperate more closely than in previous networks. On the other hand, such networks are likely to face an increasing number of industrial partners and may benefit from cooperation strengthened through unified authentication and/or authorization. As discussed previously, confederation establishment and action surveillance service involve a potentially large number of real-name authentication players. To address this, embodiments may be configured to support authentication and/or authorization services for these players. A unified authentication association is formed in a confederation group that requires user authentication data, and a distributed node network that can share authentication information. After being authenticated, the digital identity can be used to define an entity and is relatively unique. Embodiments can employ a blockchain-based certificate system which involves several authentication nodes or ID management nodes. Due to redundancy, the failure of one or more nodes does not necessarily affect the running of the entire system.

Embodiments of the present disclosure provide support for third party lawful query services. As discussed previously, a 6G network may be a multi-player network environment and business ecosystem. Embodiments provide distributed, self-organizing features for players to build a decentralized, loose ecosystem for data sharing and decentralized collaboration. Embodiments provide for trustworthy and secure interactions among different players in this ecosystem. Moreover, data security, privacy and ownership may be concerns which are addressed. Some logs and actions are not allowed to be (or are prohibited from being) distributed by laws. Log and action owners may not be willing to share their data. The legal demand and social awareness of data protection may be direct drivers for embodiments to support third party lawful query services. Based on the distributed ledger structure provided by blockchain, embodiments facilitate data transaction records to be open, transparent and traceable. This may fully reflect the status of each player in confederation group, and allow trust relationships to be established between players. The government or regulatory authority may review and query confederation information and data in compliance with applicable laws and regulations.

Various embodiments of the present disclosure related to confederation network deployment are described as follows. In a conventional 5G network, there are two typical deployment solutions, namely distributed solutions and centralized solutions. The centralized solution has advantages of global optimization and disadvantages of messaging back and forth and a single point failure. The distributed solution has advantages of distributed processing and disadvantages of significant delay to reach a converged decision. In addition, 5G networks may operate assuming that all network elements belong to the same operator and mutual trust requirements do not exist. However, according to embodiments of the present disclosure, there are multiple players, e.g., Net4AI, Net4Data and DAM modules, which do not belong to the same operator. Embodiments may adopt a centralized deployment solution in each domain and a distributed deployment solution across domains within a confederation group. For example, SCF may deploy and manage CONET agents in a first domain, domain A, while controllers in three different domains, domain A, domain B and domain C, interact in a confederation group.

In a CONET domain, the controller (e.g., CCF or SCF) deploys a CONET agent within each player, such as Net4AI, Net4DATA and DAM modules. The controller performs two functions with each CONET agent. These functions include CONET agent connection management and player action surveillance. CONET agent connection management includes basic information exchange, policy control, exception notification and heartbeat maintenance. For basic information exchange, the CONET controller interacts address, token with each CONET agent. After basic information exchange, the CONET controller configures control policy to each CONET agent including surveillance life cycle and surveillance methods. Exception notification includes CONET agent authentication exception, CONET agent data upload failure, CONET agent abnormal performance and abnormal behaviors. To assist CONET agents in operating properly, the CONET controller may keep heartbeat maintenance (regular communicative contact) to detect abnormal functioning or interruption of CONET agent, or disconnection to CONET controller.

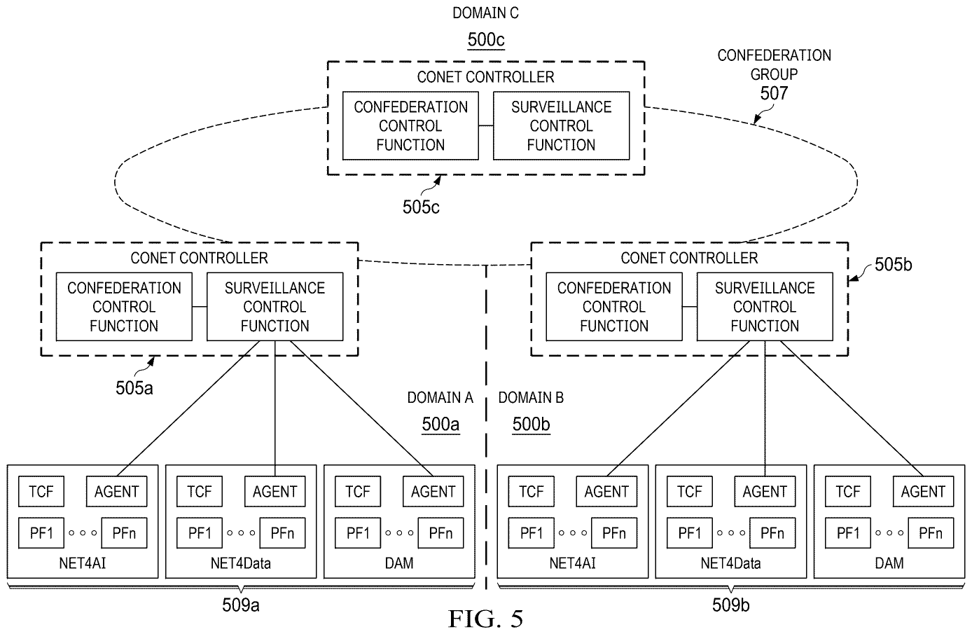

FIG. 5 illustrates, by way of example, three domains 500a, 500b, 500c, with a CONET controller 505a, 505b, 505c in each respective domain. Each CONET controller has a CCF and an SCF. The three CONET controllers may be part of a confederation group 507. Thus, confederations may involve multiple CONET controllers, while each CONET controller may manage other network modules in the confederation or in other confederations. The CCF, SCF and agents may also form parts of a confederation or multiple confederations.

FIG. 5 further illustrates sets of network modules 509a and 509b which are located within domains 500a and 500b, respectively, and which are associated with the CONET controller 505a and 505b, respectively. The network modules 509a may form a first confederation and the network modules 509b may form a second confederation. The network modules 509a and 509b may form parts of a same confederation. The SCF of each CONET controller is operatively coupled to the agents of the network modules within the same domain as that CONET controller.

Accordingly, multiple pluralities of network modules may belong to different respective network domains. A CCF, SCF and agents may be deployed in each of the network domains and associated with each of the different pluralities of network modules. A network domain may be a collection of interconnected devices organized and managed under a same administrative umbrella.

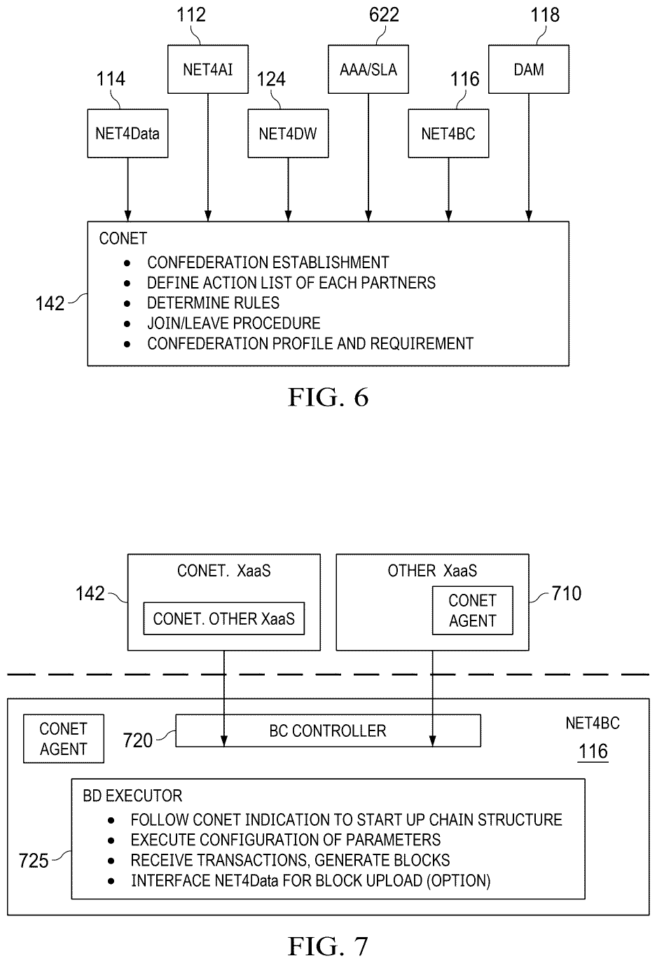

Referring now to FIG. 6, some embodiments operate at an XaaS level, using a CONET module 142 or similar approach. The CONET module 142 provides its functionality as a service to other XaaS modules, such as but not necessarily limited to Net4Data module 114, Net4AI module 112, Net4DW module 124, connectivity service module 122 or other module performing access, authentication and accounting (AAA) or SLA operations 622, Net4BC module 116, and DAM module 118. In such a scenario, the CONET module 142 operates at the XaaS level. Each player registers to the CONET module 142, and the controller performs confederation establishment, defines an action list of each player, such as actions to be performed by players, determines rules to be followed by players, processes player join and leave operations, e.g., by defining and implementing procedures to be followed for player join and leave operations, defines and facilitate interactions between players and blockchains, and obtains profile requirements. After these procedures, players (e.g., the above-mentioned modules) work together in the same group or confederation to perform defined actions.

Referring now to FIG. 7, in some embodiments the CONET modules provides services to other XaaS modules in case a required overall service involves multiple players (modules). The CONET module 142 assists other XaaS modules 710, such as Net4AI, AAA-associated, DAM and Net4Data modules to interact with the Net4BC module 116, for example when such other XaaS modules 710 need to post their information or data to blockchain. The CONET module 142 initiates the Net4BC module 116 to establish a blockchain structure, execute parameter configuration, receive transaction messages from the other XaaS modules 710 and generate blockchain blocks (records). The CONET module 142 may also initiate the Net4BC module 116 to interface with the Net4Data module for block uploads. The XaaS modules 710 and the Net4BC module 116 may form part or all of the confederation and may accordingly incorporate agent functions. The Net4BC module may include a blockchain controller 720 which controls blockchain and module operations and a blockchain executor 725 which executes functions for operating the blockchain. Therefore, one of the network modules of the confederation may be a blockchain module configured to manage blockchain execution. In such embodiments, the CCF may be configured to facilitate the interaction between the other network modules and the blockchain module.

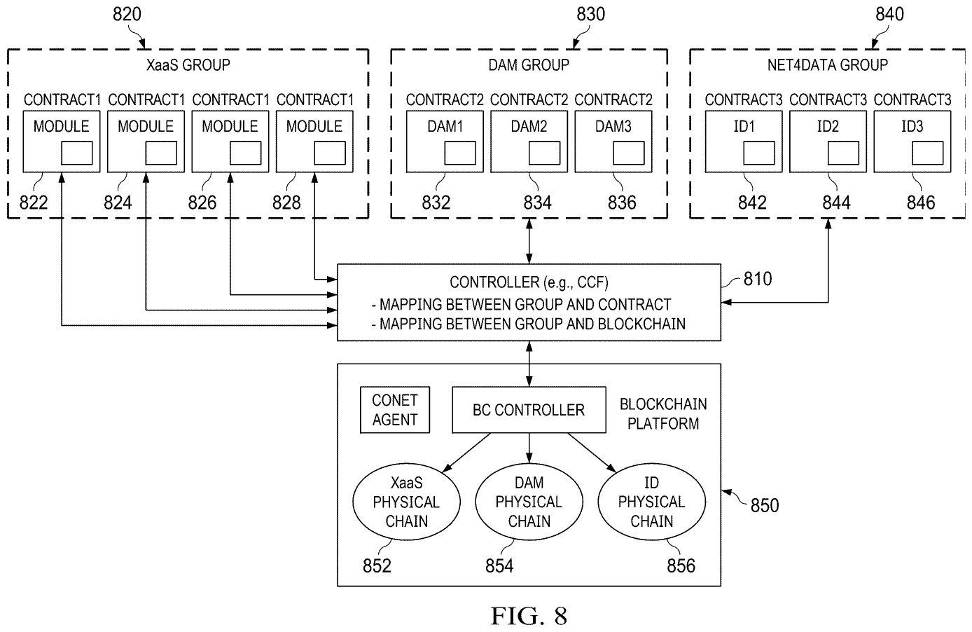

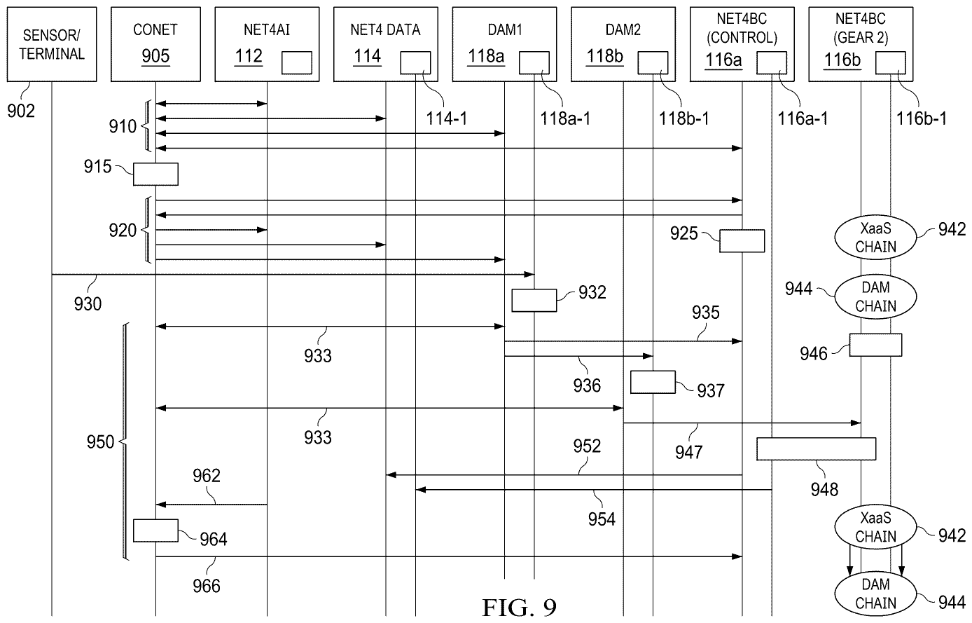

Referring now to FIG. 8, embodiments of the present disclosure may include the following operations. First, players (network modules) register to the controller 810 (e.g., the CCF thereof). The controller allocates different players into different groups or sub-groups. For example, the controller 810 may allocate multiple modules 822, 824, 826, 828 into a first XaaS group or sub-group 820. As another example, the controller may allocate DAM modules DAM1 832, DAM2 834 and DAM3 836 into a DAM group or sub-group 830. As another example, the controller may allocate modules ID1 842, ID2 844 and ID3 846 (e.g., which are Net4Data modules) into a Net4Data group or sub-group 840. More generally, the controller or CCF thereof establishes one, two or more groups or sub-groups, each including two or more network modules. Different modules within a same group or sub-group have the same contract. Different groups can have different contracts. The controller may establish mappings between groups and contracts, for example as referenced by associated group identifiers and contract identifiers, respectively. Thus, the controller or CCF is configured to associate each group or sub-group with a different respective contract, such that all members of a same group or sub-group are associated with a same contract.

Further, the controller 810 replies to each player with group or sub-group and contract information, and requests (and subsequently obtains) player profile information. Further, each player obtains and records group or sub-group and contract information and replies to the controller 810 with its profile information. Further, the controller 810 obtains profile information and establishes mappings between groups or sub-groups and blockchains for supporting those groups or sub-groups. Each group or sub-group 820, 830, 840 is associated with a particular blockchain, which is given a chain ID. The controller 810 provides an indication to the blockchain platform 850 to build these blockchains. Thus, the blockchain platform 850 establishes an XaaS blockchain 852 associated with the group or sub-group 820, a DAM blockchain 854 associated with the DAM group or sub-group 830, and an ID blockchain 856 associated with the Net4Data group or sub-group 840. Each of the blockchains 852, 854, 856 can be used to record actions or other data posted by or regarding its associated group or sub-group.

It is noted that contracts may be associated with groups and work at the XaaS Service layer. Contract interaction may be managed and completed by CONET controller. It is also noted that the DAM modules or ID modules (842, 844, 846) can form a group, register with the management and control system for the CONET controller, and feed back the service table. The service table may be fed back by a module to the CONET controller. The service table may indicate what the module requires from the confederation network. It is also noted that the blockchain platform 850 (e.g., Net4BC module) may be responsible for only the physical blockchains chain, and the parameters of the blockchains may be configured by the CONET controller. It is also noted that cross-chain interaction (e.g., involving controllers 505a, 505b, 505c) may be triggered by contracts at the service layer. According to cross-chain interaction, two blockchains may interact. The interaction may be initiated by the CCF upon determining that it is required. The controller may be used to find an appropriate blockchain for such interaction. The CONET notifies the blockchain platform to facilitate the interaction between two blockchains.

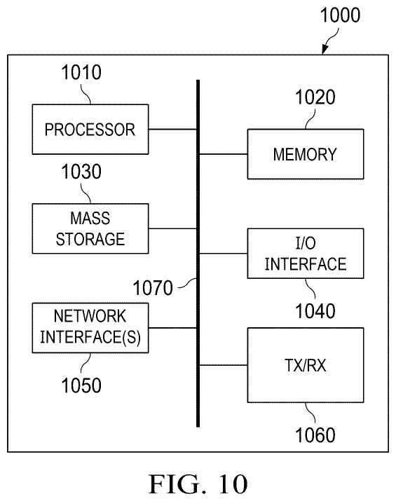

FIG. 9 illustrates an example operation of embodiments, including surveillance DAM (DAM action monitoring and surveillance) and cross-chain interaction. A CONET controller 905 performs confederation establishment 910, by establishing a confederation of multiple XaaS modules, including a Net4AI module 112, a Net4Data module 114, a first DAM module 118a, a second DAM module 118b, and a Net4BC controller 116a. The Net4BC gear 2 116b, also referred to as the Net4BC executor, may perform blockchain operations in response to commands from the Net4BC controller, and may thus also be considered part of the confederation. The net4BC gear 2 116b may include a data plane aspect 116b-1 which participates in data plane operations. This may involve communication via IF-1. Subsequently the controller 905 maintains 915 records and translates blockchain profiles. Translation may involve translating module requirements into a blockchain feature such as a blockchain profile. In operation 920, the controller 905 then transmits the chain profiles to various modules, for example via IF-2. This can include transmitting to the Net4BC controller 116a, receiving a reply, and transmitting to other modules such as the Net4AI module 112, Net4Data module 114, and first DAM module 118a. The first Net4BC module 116 a also performs 925 internal development and configuration, and keep records in the form of a table.

One or more sensors or terminals 902 perform a chain profile transmission 930 (e.g., via IF-2) to the first DAM module 118a, or more particularly to a data plane aspect 118a-1 of the first DAM module 118a. The first DAM module 118a (or the data plane aspect 118a-1 thereof) subsequently performs an associated data collection action 932. This and the following are part of an operation phase 950. Heartbeat and warning and mode control messages 933 can be exchanged between the controller 905 and other modules such as the DAM modules 118a and 118b.

The DAM module 118a can perform action notification 935 by messaging the Net4BC controller 116a. This may result in a translation and writing of actions 945 to the blockchain by the Net4BC gear 2 116b. This may include writing to the XaaS chain 942, DAM chain 944, or both. A message 936 form the first DAM module 118a to the second DAM module 118b (or more particularly to a data plane aspect 118b-1 of the second DAM module 118b) may trigger a data sanitization action 937 by the second DAM module 118b or by the data plane aspect 118b-1 thereof. Another action notification 947 from the second DAM module 118b to the Net4BC gear 2 116b may trigger a block storage action 948 by the Net4BC controller 116a or a data plane aspect 116a-1 thereof, Net4BC gear 2 116b, or both. This may be followed by a block upload request 952 from the Net4BC controller 116a to the Net4Data module 114, and the associated block 954 which may be passed from the data plane aspect 116a-1 of the Net4BC controller 116a to a data plane aspect 114-1 of the Net4Data module 114.

A cross chain interaction request 962, for example specifying a contract ID, may be sent from the Net4AI module 112 to the CONET controller 905. In response, the CONET controller 905 may perform a translation 964 of the request and provide the translated request to the Net4BC controller 116a. The translated request may include one or more chain IDs. This may result in subsequent cross-chain interaction between the XaaS chain 942 and the DAM chain 944.

FIG. 10 is a schematic diagram of a computing device 1000 that may perform any or all of operations of the methods and features explicitly or implicitly described herein, according to different embodiments of the present disclosure. For example, a computer equipped with functionality of the present disclosure may be configured as the computing device 1000. One, two or more such computing devices may be coupled together in order to provide embodiments of the present disclosure, for example as an apparatus or system, or of entities performing a method. Multiple physically separate devices (e.g., in the same or separate datacenters) may be coupled together in order to provide one, two or more of such computing devices. When a device provides an infrastructure module, that device may consist primarily of an associated resource. For example, a computing module may consist primarily of computer processors, while a storage module may consist primarily of computer memory.

As shown, the device 1000 may include a processor 1010, such as a Central Processing Unit (CPU) or specialized processors such as a Graphics Processing Unit (GPU) or other such processor unit, memory 1020, non-transitory mass storage 1030, input-output interface 1040, network interface 1050, and a transceiver 1060, all of which are communicatively coupled via bi-directional bus 1070. According to certain embodiments, any or all of the depicted elements may be utilized, or only a subset of the elements. Further, device 1000 may contain multiple instances of certain elements, such as multiple processors, memories, or transceivers. Also, elements of the hardware device may be directly coupled to other elements without the bi-directional bus. Additionally, or alternatively to a processor and memory, other electronics, such as integrated circuits, may be employed for performing the required logical operations.

The memory 1020 may include any type of non-transitory memory such as static random access memory (SRAM), dynamic random access memory (DRAM), synchronous DRAM (SDRAM), read-only memory (ROM), any combination of such, or the like. The mass storage element 1130 may include any type of non-transitory storage device, such as a solid state drive, hard disk drive, a magnetic disk drive, an optical disk drive, USB drive, or any computer program product configured to store data and machine executable program code. According to certain embodiments, the memory 1020 or mass storage 1030 may have recorded thereon statements and instructions executable by the processor 1010 for performing any of the aforementioned method operations described above.

Embodiments of the present disclosure can be implemented using electronics hardware, software, or a combination thereof. In some embodiments, the disclosure is implemented by one or multiple computer processors executing program instructions stored in memory. In some embodiments, the disclosure is implemented partially or fully in hardware, for example using one or more field programmable gate arrays (FPGAs) or application specific integrated circuits (ASICs) to rapidly perform processing operations.

It will be appreciated that, although specific embodiments of the disclosure have been described herein for purposes of illustration, various modifications may be made without departing from the scope of the disclosure. The specification and drawings are, accordingly, to be regarded simply as an illustration of the disclosure as defined by the appended claims, and are contemplated to cover any and all modifications, variations, combinations or equivalents that fall within the scope of the present disclosure. In particular, it is within the scope of the disclosure to provide a computer program product or program element, or a program storage or memory device such as a magnetic or optical wire, tape or disc, or the like, for storing signals readable by a machine, for controlling the operation of a computer according to the method of the disclosure and/or to structure some or all of its components in accordance with the system of the disclosure.

Acts associated with the method described herein can be implemented as coded instructions in a computer program product. In other words, the computer program product is a computer-readable medium upon which software code is recorded to execute the method when the computer program product is loaded into memory and executed on the microprocessor of the wireless communication device.

Further, each operation of the method may be executed on any computing device, such as a personal computer, server, PDA, or the like and pursuant to one or more, or a part of one or more, program elements, modules or objects generated from any programming language, such as C++, Java, or the like. In addition, each operation, or a file or object or the like implementing each said operation, may be executed by special purpose hardware or a circuit module designed for that purpose.

Through the descriptions of the preceding embodiments, the present disclosure may be implemented by using hardware only or by using software and a necessary universal hardware platform. Based on such understandings, the technical solution of the present disclosure may be embodied in the form of a software product. The software product may be stored in a non-volatile or non-transitory storage medium, which can be a compact disc read-only memory (CD-ROM), USB flash disk, or a removable hard disk. The software product includes a number of instructions that enable a computer device (personal computer, server, or network device) to execute the methods provided in the embodiments of the present disclosure. For example, such an execution may correspond to a simulation of the logical operations as described herein. The software product may additionally or alternatively include a number of instructions that enable a computer device to execute operations for configuring or programming a digital logic apparatus in accordance with embodiments of the present disclosure.

Although the present disclosure and implementation(s) associated therewith have been described with reference to specific features and embodiments, it is evident that various modifications and combinations can be made thereto without departing from such implementation(s). The specification and drawings are, accordingly, to be regarded simply as an illustration of embodiments of the disclosure, for example as defined by the appended claims, and are contemplated to cover any and all modifications, variations, combinations or equivalents that fall within the scope of the present disclosure and its implementation(s).

What is claimed is:

1. A method, performed by a plurality of network functions, comprising:
establishing and managing, by a first function of the plurality of network functions, a confederation involving a plurality of network modules, the confederation providing a service via cooperation of the plurality of network modules, wherein the plurality of network functions are established using networked computing resources and are operatively coupled together;
generating, by a plurality of second functions of the plurality of network functions, a record of actions taken by a respective one of the plurality of network modules, wherein each of the plurality of second functions is integrated into said respective one of the plurality of network modules; and
deploying and communicating, by a third function of the plurality of network functions, with the plurality of second functions, and performing surveillance of actions taken by the plurality of network modules, said surveillance of actions based at least in part on said record of actions.

2. The method of claim 1, further comprising, by the first function, directing a blockchain service to establish a blockchain to support the service, and directing the plurality of modules to utilize the blockchain for providing the service.

3. The method of claim 1, further comprising, by the first function, performing or triggering authentication or authorization of each of the plurality of network modules, and admitting each of the plurality of network modules to the confederation after successful completion of said authentication or authorization.

4. The method of claim 1, further comprising, by the first function:
obtaining information indicative of location of each of multiple network modules and services provided by each of the multiple network modules; and
selecting the plurality of network modules from the multiple network modules to form the confederation based on the obtained information.

5. The method of claim 1, wherein the first function provides or is operatively coupled to a registration authority (RA), the method further comprising, by the RA, verifying identify of the plurality of network modules and obtaining and distributing certificates authenticating each of the plurality of network modules, the certificates obtained from a certification authority (CA) operatively coupled to the registration authority, the certification authority operating using a cryptographic certification system.

6. The method of claim 1, wherein the confederation comprises a main group and at least one sub-group, the main group comprising the first function, the plurality of second functions, and the third function, each sub-group comprising two or more of the plurality of network modules.

7. The method of claim 1, further comprising, by the first function, establishing one or more contracts to be followed by the plurality of network modules in providing the service, the one or more contracts defining one or more of: rules for performing read or modify operations on status database information; or rules for performing service logic or execution operations.

8. The method of claim 1, further comprising, by the third function, maintaining or managing maintenance of the record of actions taken by said respective one of the plurality of network modules, and providing the record of actions to the plurality of network modules.

9. The method of claim 1, further comprising maintaining and managing the first function, the third function, and the plurality of second functions.

10. The method of claim 1, further comprising receiving and responding to queries from government or regulatory authority agencies, at least in part by providing information obtained by the third function to said government or regulatory authority agencies upon determining that it is lawful to receive and respond to the queries.

11. The method of claim 1, wherein the plurality of network modules and the plurality of network functions belong to a same first domain of a computer network, and the method further comprises:
operating a second plurality of network functions belonging to a second domain of the computer network different from the first domain, wherein the second plurality of network functions comprise:
a fourth function configured to establish and manage a second confederation involving a second plurality of network modules belonging to the second domain, the second confederation contributing to providing the service via cooperation of the second plurality of network modules;
a plurality of fifth functions, each integrated into a respective one of the second plurality of network modules and configured to generate a second record of actions taken by said respective one of the second plurality of network modules; and
a sixth function configured to deploy and communicate with a second plurality of fifth functions, and to perform surveillance of actions taken by the second plurality of network modules, said surveillance of actions based at least in part on said second records of actions.

12. The method of claim 1, further comprising, by the first function, maintaining regular communicative contact with each of the second functions to detect abnormal functioning or disconnection thereof.

13. The method of claim 1, further comprising, by the first function, performing at least one of: defining a respective list of actions to be performed by each of the plurality of network modules; determining rules to be followed by the plurality of network modules; defining and implementing a procedure to be followed by the plurality of network modules to join the confederation; defining and implementing a procedure to be followed by the plurality of network modules to leave the confederation; or defining and facilitating interaction between the plurality of network modules and one or more blockchains.

14. The method of claim 1, wherein one of the plurality of network modules is a blockchain network module configured to manage blockchain execution, the method further comprising, by the first function, facilitating interaction between one or more of the plurality of network modules and the blockchain network module.

15. The method of claim 1, further comprising, by the first function, establishing two or more sub-groups each comprising two or more of the plurality of network modules.

16. The method of claim 15, further comprising, by the first function, associating each of the two or more sub-groups with a respective one of two or more contracts, such that members of a same one of the two or more sub-groups are associated with a same one of the two or more contracts.

17. The method of claim 15, further comprising, by the first function, obtaining profile information from each of the plurality of network modules.

18. The method of claim 15, further comprising, by the first function, establishing mappings between each one of the two or more sub-groups and a respective blockchain for said one of the two or more sub-groups.

19. A system, comprising a plurality of network functions, the network functions including:
a first function configured to establish and manage a confederation involving a plurality of network modules, the confederation providing a service via cooperation of the plurality of network modules;
a plurality of second functions, each integrated into a respective one of the plurality of network modules and configured to generate a record of actions taken by said respective one of the plurality of network modules; and
a third function configured to deploy and communicate with the plurality of second functions, and to perform surveillance of actions taken by the plurality of network modules, said surveillance based at least in part on said record of actions.

20. A non-transitory computer readable storage medium, comprising instructions that, when executed by one or more processors, cause the one or more processors to perform operations comprising:
establishing and managing, by a first function of a plurality of network functions, a confederation involving a plurality of network modules, the confederation providing a service via cooperation of the plurality of network modules, wherein the plurality of network function are established using networked computing resources and are operatively coupled together;
generating, by a plurality of second functions of the plurality of network functions, a record of actions taken by a respective one of the plurality of network modules, wherein each of the plurality of second functions is integrated into said respective one of the plurality of network modules; and
deploying and communicating, by a third function of the plurality of network functions, with the plurality of second functions, and performing surveillance of actions taken by the plurality of network modules, said surveillance of actions based at least in part on said record of actions.
